(19) United States
(12) Patent Application Publication
(10) Pub. No.: US 2025/0339783 A1
(43) Pub. Date: Nov. 6, 2025

(54) MOBILE DEVICE HOLDER FOR A COMPUTER GAME CONTROLLER

(71) Applicant: GAME CHANGER ACCESSORIES LIMITED, Watford (GB)

(72) Inventor: Inderjeet Singh, Watford (GB)

(21) Appl. No.: 18/958,869

(22) Filed: Nov. 25, 2024

(30) Foreign Application Priority Data
May 2, 2024 (GB) 2406145.9

(51) Int. Cl. A63F 13/98

(52) U.S. Cl. CPC A63F 13/98

(57) ABSTRACT

A mobile device holder for mounting a mobile computing device to a computer game controller includes a support frame and a clamp member. The clamp member has a lower jaw defining a recess for receiving the base of a game controller, and an upper jaw that extends around the top of a said game controller, in use. The lower and upper jaws hinged together at a rear edge of the clamp, and releasably securable together at an opposing front edge so as to, in use, encircle a central portion of a game controller. The lower jaw incorporates an inner surface facing the upper jaw and an opposing outer surface including connecting means. The support frame includes a support member for removably receiving and holding a mobile computing device, and means for removably securing the support frame to the connecting means of the lower jaw of the clamp member.

### CROSS-REFERENCE TO RELATED APPLICATIONS

This application claims the benefit of, or priority to, United Kingdom Patent Application 2406145.9, filed on May 2, 2024, all of which are hereby incorporated by reference in their entirety for all purposes.

### FIELD OF THE INVENTION

This invention relates to a holder for a holder for a hand-held computer game controller, to enable a mobile device, such as a mobile phone, to be mounted thereto.

### BACKGROUND OF THE INVENTION

Earphones and headphones are well known and in widespread use for enabling users to hear audio signals such as music or speech. Whilst the terms are often used interchangeably, headphones tend to comprise a pair of speakers joined by a band worn over a user's head so that the speakers fit over the user's ears, whereas earphones or, more precisely, in-ear earphones are designed to fit inside the ear canal with the intention of keeping sound in and extraneous background noise out.

Computer gaming has become increasingly prevalent in recent years. Computer gaming equipment generally comprises a stationary console that is coupled to a monitor that displays the game progress, and one or more separate, hand-held, game controllers or allowing game players to control the game.

In many cases, the game player may want to mount their mobile device, such as a mobile phone or small tablet device, to their game controller so that, for example, they can play a game on their device or use their device as the monitor for their game. However, game controllers, such as those for Playstation® or Xbox® games consoles, tend to be of a rounded, ergonomic and irregular shape, making it impossible to use a standard clamp or mounting device for this purpose, especially as the buttons and or joysticks thereon need to be kept clear and unencumbered.

Mobile phone supports for game controllers have been proposed that comprise a support frame for supporting a mobile phone, the support frame being integrally coupled to a cradle in which the game controller can be received and supported, so as to mount the support frame vertically above the game controller. However, a number of drawbacks are associated with these types of device. Firstly, using an open cradle to support the game controller makes the assembly insecure and off-balance, thus making the game controller more difficult to use normally, and running the risk that the support device will become detached from the game controller during use. Furthermore, the cradle must be made to fit the dimensions of a particular game controller and, as game controllers for a particular games console evolve and change, so do their shape and dimensions, so that every time a gamer buys a new game controller, they are likely to have to buy a whole new mobile phone support device.

An aspect of the present invention seeks to address at least one or more of these issues.

### SUMMARY OF THE INVENTION

According to an aspect of the present invention, there is provided a mobile device holder for mounting a mobile computing device to a computer game controller, the mobile device holder comprising a support frame and a clamp member, said clamp member comprising a lower jaw defining a recess configured to receive therein, in use, the base of a game controller, and an upper jaw configured, in use, to extend around the top of a said game controller, the lower and upper jaws being hingedly coupled together at a rear edge of said clamp, and releasably securable together at an opposing front edge thereof so as to, in use, encircle a central portion of a said game controller; wherein said lower jaw comprises an inner surface facing said upper jaw and an opposing outer surface having thereon connecting means; and the support frame includes a support member configured to removably receive and hold therein a mobile computing device, and means for removably securing said support frame to said connecting means of said lower jaw of said clamp member.

Beneficially, the connecting means may comprise a mounting recess defined by a pair of substantially parallel and spaced apart retaining edges provided or formed on said outer surface of said lower jaw of said clamp member, and wherein said support frame includes a tab configured to be received and retained in said mounting recess, in use.

In an embodiment, cooperative magnetic means may be provided in said mounting recess and on said support frame, and configured to removably secure said support frame to said connecting means of said lower jaw of said clamping member.

Beneficially, the front edge of said lower jaw may comprise an outwardly extending lip including releasably securing means for, in use, securing the front edge of the lower jaw to cooperative securing means provided at the front edge of said upper jaw.

Optionally, the releasably securing means may comprise one or more magnets configured to be attracted to one or more magnets provided at the front edge of said upper jaw.

Beneficially, the upper jaw may comprise at least one opening therein for accommodating one or more control devices (or other feature) provided on a said game controller.

The support frame may comprise a support arm extending between a lower edge of said support member and said means for removably securing said support frame to said connecting means of said lower jaw of said clamp member. Beneficially, the support member may be adjustably (e.g. hingedly) attached to said support arm by means of a releasably securing device.

These and other aspects of the invention will be apparent from the following detailed description.

### BRIEF DESCRIPTION OF THE DRAWINGS

Embodiments of the present invention will now be described, by way of examples only, and with reference to the accompanying drawings, in which:

FIG. 1 is a schematic rear perspective view of the support frame and clamp of a mobile device holder according to a first exemplary embodiment of the present invention, in a disassembled configuration, the support frame thereof having a mobile phone supported therein;

FIG. 2 is a schematic front perspective view of the mobile device holder of FIG. 1;

FIG. 3 is a schematic rear perspective view of the mobile device holder of FIG. 1, in an assembled configuration and mounted on a game controller;

FIG. 4 is a schematic front perspective view of the mobile device holder of FIG. 3;

FIG. 5 is a schematic rear perspective view of a mobile device holder according to another exemplary embodiment of the present invention, in a disassembled configuration, the support frame thereof having a mobile phone supported therein;

FIG. 6 is a schematic front perspective view of the mobile device holder of FIG. 5;

FIG. 7 is a schematic rear perspective view of the mobile device holder of FIG. 1, in an assembled configuration and mounted on a game controller; and

FIG. 8 is a schematic front perspective view of the mobile device holder of FIG. 7.

### DETAILED DESCRIPTION OF THE INVENTION

In the following description of various exemplary embodiments of the invention, reference is made to the accompanying drawings that form a part hereof, and in which are shown, by way of examples and illustration, specific embodiments in which the invention may be practiced. These embodiments are described in sufficient detail to enable those skilled in the art to practice the invention, and it is to be understood that other embodiments may be utilized and that variations and modifications may be made, without departing from the scope of the invention as defined in the appended claims. The following detailed description is therefore not to be taken in a limited sense.

The specification may refer to “an”, “one” or “some” embodiment(s) in some parts. This does not necessarily imply that each such reference is to the same embodiment(s), or that the feature applies to only one embodiment. Single features of different embodiments may also be combined to make another embodiment.

As used herein, the singular forms “a”, “an” and “the” are intended to include the plural forms as well, unless expressly stated otherwise. It will be further understood that the terms “includes”, “comprises”, “including” and/or “comprising”, when used in this specification, specify the presence of stated features, integers, steps, operations, elements and/or components, but do not preclude the presence or addition of one or more other features, integers, operations, steps, elements, components and/or groups thereof As used herein, the term “and/or” includes any and all combinations and arrangements of one or more of the associated listed items.

Directional descriptors such as upper, lower, left, right, clockwise, anti-clockwise, front, rear and other similar adjectives are used for clarity and refer to the orientation of the invention as illustrated in the drawings, however it will be clear to those skilled in the art that the invention may not always be oriented as illustrated and the invention is not intended to be limited in this regard.

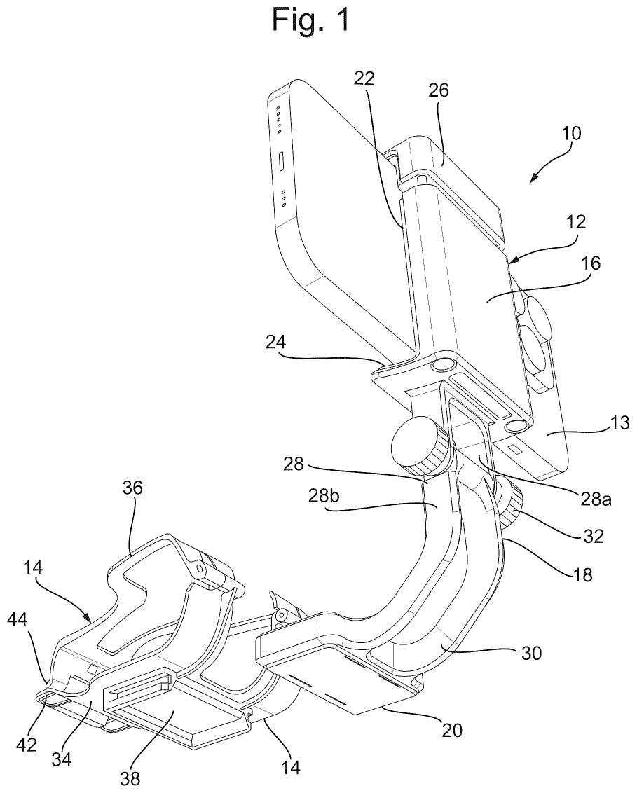

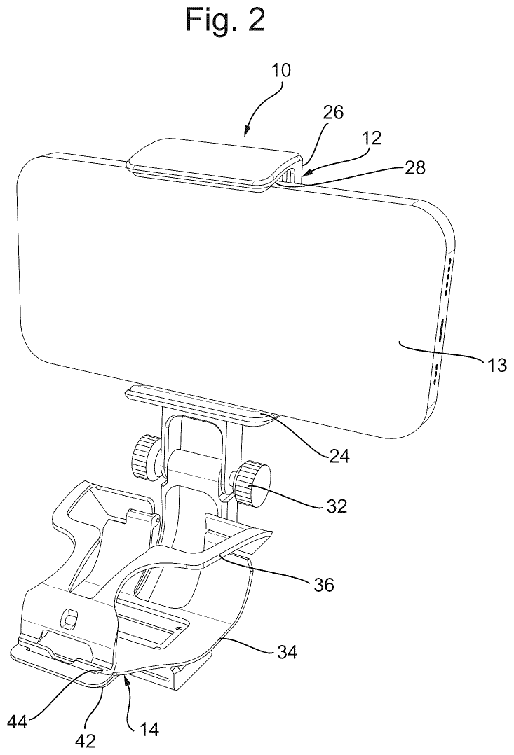

Referring to FIGS. 1 and 2 of the drawings, a mobile device holder 10 according to a first exemplary embodiment of the present invention, comprises a support frame 12 and a clamp 14. The support frame 12 comprises a mount 16 coupled at its lower end to a generally J-shaped arm 18, the distal end of the J-shaped arm being integrally coupled with a generally rectangular tab 20. The mount 16 is generally rectangular and comprises a support plate 22, the plane of which is generally in-line with the elongate portion of the J-shaped arm 18 and comprises an integral first end wall 24 along it lower edge (when the mobile device holder is oriented for normal use, as shown in FIGS. 1 and 2 of the drawings), the end wall 24 extending substantially orthogonally to the plane of the support plate 22. The mount 16 further comprises a clamping member 26, slidably mounted relative to, and spring biased toward, the support plate 22, the clamping member 26 being of generally L-shaped profile, so as to define a second end wall 28, substantially parallel to, and vertically spaced apart from, the first end wall 24 (when the mobile device holder is oriented for normal use, as shown in FIGS. 1 and 2 of the drawings).

The elongate portion 28 of the J-shaped arm 18 comprises two separate elongate sections 28a, 28b. A first section 28a of the arm 18 is integrally coupled to the lower edge of the mount 16 and the second section 28b of the arm 18 is integrally coupled to a curved section 30 that terminates at the rectangular tab 20. The two sections 28a, 28b of the arm 18 are hingedly connected together by a releasable hinge pin 32, that, when released, allows the angle of the plane of the support plate 22 to be adjusted about the axis defined by the hinge pin 32 and, when tightened, fixes the angle of the support plate 22 as desired.

The plane of the generally rectangular tab 20 is substantially horizontal when the mobile device holder 10 is oriented for normal use, and may have incorporated therein one or more magnets.

In use, a user can place a side edge of a mobile device 13 against the second end wall 28 of the clamping member 26 and push it upwards relative to the support plate 22, against the spring bias, to open the gap between the first and second end walls 24, 28, to allow the mobile device 13 to be inserted into the recess between them. The clamping member 26 can then be released to clamp the mobile device 13 between the first and second end walls 24, 28. The angle of the mobile device relative to the clamp 164 can be adjusted by releasing the hinge pin 32, pivoting the support plate 22 to the desired angle and then securing the hinge pin 32 to fix the mobile device 13 at the desired angle.

The clamp 14 comprises a lower jaw 34 and an upper jaw 36, the lower and upper jaws 34, 36 being hingedly coupled together at a rear edge.

The lower jaw 34 has an inner surface (facing the upper jaw 36) and an opposing outer surface. A mounting recess 38 is integrally formed on the outer surface of the lower jaw 34. The mounting recess 38 has a pair of recessed side edges configured to slidably receive and retain therein the tab 20 of the support frame 12. One or more magnets (of opposite polarity to any magnet(s) in the tab 20) may be incorporated into the mounting recess 38 for additional stability and security.

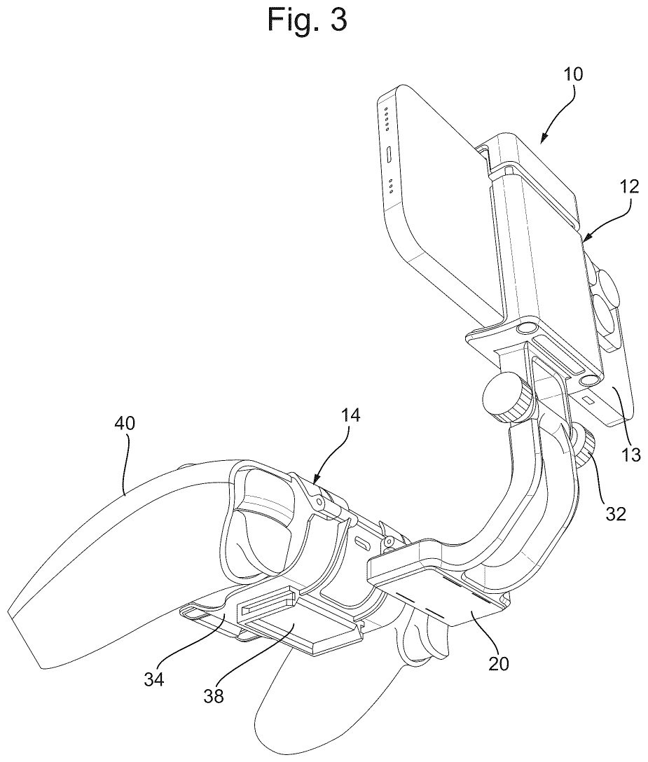

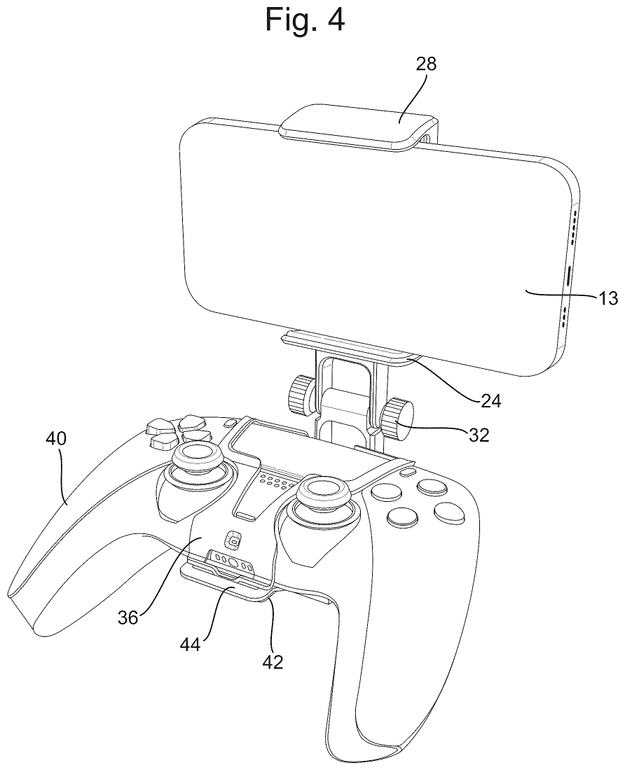

Referring additionally to FIGS. 3 and 4 of the drawings, the lower jaw 34 has a generally planar central section, and is curved at the rear and front edges to conform to outer contours of the central bottom and rear sections of a particular game controller (in this case a Playstation® controller) such that, in use, the central bottom section and rear edge of the game controller 40 sit within the lower jaw 34, flush with its inner surface. The front edge of the lower jaw 34 comprises an integral first lip 42 that, in use, extends outwardly from the lower front edge of the game controller 40, and includes fastening means (such as one or more magnets).

The upper jaw 36 is shaped and configured to conform to the central upper surface of the game controller 40. In the example illustrated in FIGS. 1 to 4 of the drawings, the upper jaw 36 comprises a main body that extends between the front and rear edges of the clamp 14, the rear end of the main body extending downwardly and terminating at an edge that is hingedly coupled to the lower jaw 36, and the front end of the main body extending downwardly and terminating at a second lip 44 that includes fastening means (such as one or more magnets of opposite polarity to those in the first lip 42 of the lower jaw 34) to enable the first and second lips 42, 44 to be releasably secured together, thereby securing the clamp 16 all the way around the central part of the game controller 40, in use.

As shown in FIG. 4 of the drawings, the main body of the upper jaw 36 is contoured and configured to leave the control buttons and joysticks of the game controller 40 for which it is designed free and unencumbered, whilst maximizing the surface area of the central portion of the game controller over which the upper jaw 36 extends, thereby maximizing the stability of the mobile device holder, in use, without adversely affecting the user's enjoyment or ability to use the game controller in a normal manner, whilst also minimizing the weight of the mobile device holder. Accordingly, in the particular embodiment illustrated in FIGS. 1 to 4 of the drawings, the main body of the upper jaw 36 comprises a rear section and a front section, the rear section being broader than the front section and extending, in use, between the side buttons of the particular game controller 40 illustrated. The main body of the upper jaw 36 becomes progressively narrower from the rear to the front, and has a pair of opposing, concave side edges at the front to accommodate a pair of joysticks located at the front edge of the game controller 40. A central opening is provided in the main body of the upper jaw 36 so as to minimize the weight of the upper jaw 36 and also to accommodate the speaker holes in the front section of the game controller 40. An opening may also be provided in the front edge of the upper jaw 36, to accommodate a charging port or jack.

When the mobile device holder is oriented for normal use, the (fixed) second section 28b of the J-shaped arm 28, extends generally vertically upward at one end, and curves at the opposite end, where the tab 20 is integrally formed. The plane of the tab 20 is substantially horizontal, when oriented for normal use. Accordingly, the plane along which the clamp 14 extends is also substantially horizontal.

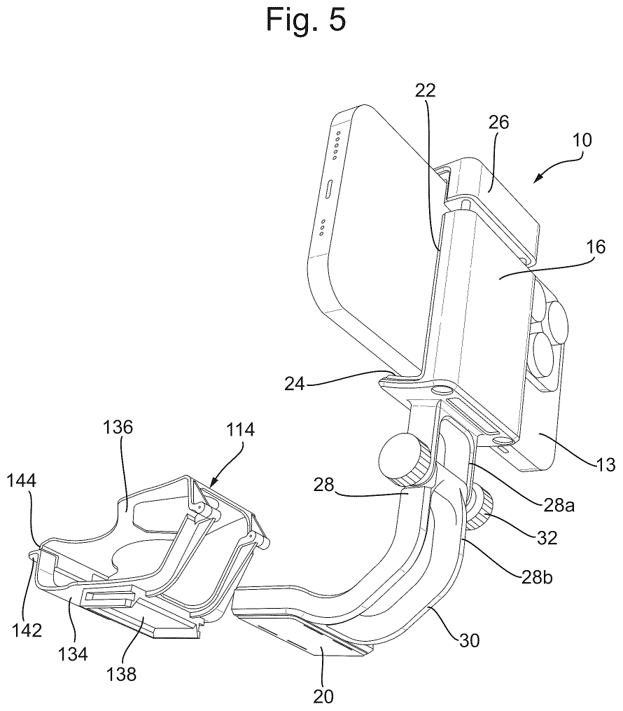

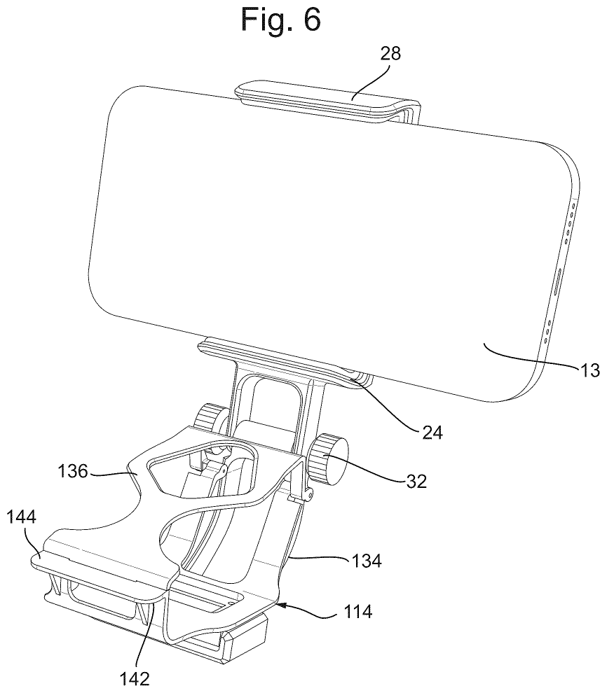

Referring now to FIGS. 5 to 8 of the drawings, a mobile device holder 100 according to a second exemplary embodiment is illustrated schematically, and is intended for a different game controller, namely an Xbox® controller 140. In this case, the support frame 12 is identical to that described with reference to FIGS. 1 to 4 (because it can be used interchangeably with several different clamps), and will therefore not be described again.

The clamp 114 once again comprises a lower jaw 134 and an upper jaw 136, the lower and upper jaws 134, 136 being hingedly coupled together at a rear edge.

The lower jaw 134 has an inner surface (facing the upper jaw 136) and an opposing outer surface. A mounting recess 138 is integrally formed on the outer surface of the lower jaw 134. The mounting recess 138 has a pair of recessed side edges configured to slidably receive and retain therein the tab 20 of the support frame 12. One or more magnets (of opposite polarity to any magnet(s) in the tab 20) may be incorporated into the mounting recess 138 for additional stability and security.

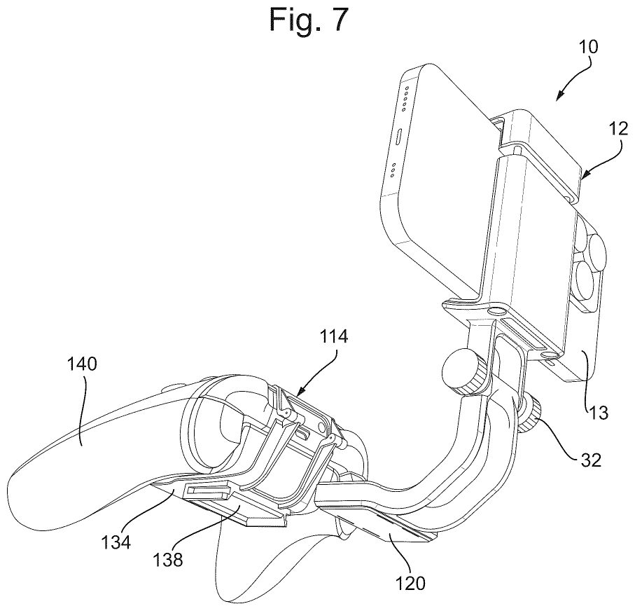

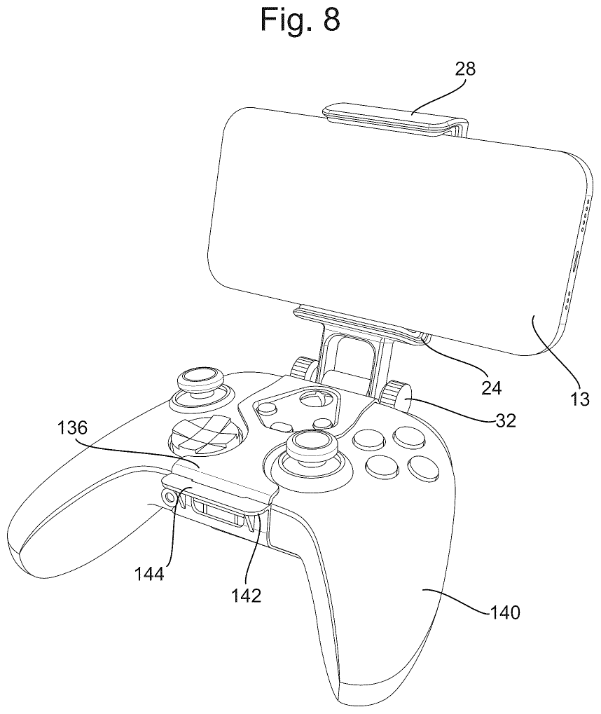

Referring particularly to FIGS. 7 and 8 of the drawings, the lower jaw 134 has a generally planar central section, and is curved at the rear and front edges to conform to outer contours of the central bottom and rear sections of a particular games controller (in this case a Playstation®) such that, in use, the central bottom section and rear edge of the game controller 140 sit within the lower jaw 134, flush with its inner surface. The front edge of the lower jaw 134 comprises an integral first lip 142 that, in use, extends outwardly from the lower front edge of the game controller 140, and includes fastening means (such as one or more magnets).

The upper jaw 136 is shaped and configured to conform to the central upper surface of the game controller 140. In the example illustrated in FIGS. 5 to 8 of the drawings, the upper jaw 136 comprises a main body that extends between the front and rear edges of the clamp 114, the rear end of the main body extending downwardly and terminating at an edge that is hingedly coupled to the lower jaw 136, and the front end of the main body extending downwardly and terminating at a second lip 144 that includes fastening means (such as one or more magnets of opposite polarity to those in the first lip 142 of the lower jaw 134) to enable the first and second lips 142, 144 to be releasably secured together, thereby securing the clamp 114 all the way around the central part of the game controller 140, in use.

As shown in FIG. 8 of the drawings, the main body of the upper jaw 136 is contoured and configured to leave the control buttons and joysticks of the game controller 140 for which it is designed free and unencumbered, whilst maximizing the surface area of the central portion of the game controller over which the upper jaw 136 extends, thereby maximizing the stability of the mobile device holder, in use, without adversely affecting the user's enjoyment or ability to use the game controller in a normal manner, whilst also minimizing the weight of the mobile device holder. Accordingly, in the particular embodiment illustrated in FIGS. 5 to 8 of the drawings, the main body of the upper jaw 136 comprises a rear section and a front section, the rear section is of substantially the same width as the front section and extending, in use, between the side buttons on one side of the particular game controller 140 illustrated and the joystick on the other side. The main body of the upper jaw has a pair of opposing, concave side edges at the front to accommodate a pair of joysticks located at the front edge of the game controller 140. A central opening is provided in rear section of the main body of the upper jaw 136 so as to accommodate a set of control buttons in the centre of the rear portion of the game controller 140. Once again, an opening may also be provided in the front edge of the upper jaw 136, to accommodate a charging port or jack.

Once again, when the mobile device holder is oriented for normal use, the (fixed) second section 28b of the J-shaped arm 28 of the support frame 12, extends generally vertically upward at one end, and curves at the opposite end, where the tab 20 is integrally formed. The plane of the tab 20 is substantially horizontal, when oriented for normal use. Accordingly, the plane along which the clamp 114 extends is also substantially horizontal.

As the support frame 12 and clamp 16, 114 are removably secured together, if the user subsequently upgrades or changes their game controller to one of a different configuration, they would only need a new clamp to fit the body of the new controller and could use the same support frame. In addition, as the clamp is designed to go all the way around the central section of a game controller, without interfering with the control buttons and joysticks thereon, the stability of the mobile device holder can be significantly improved over the prior art, without causing any inconvenience to the user, whilst ensuring that the weight of the mobile device holder is not prohibitively high.

It will be appreciated by a person skilled in the art, from the foregoing description, that modifications and variations can be made to the described embodiments, without departing from the scope of the invention as defined in the appended claims. In particular, it will be appreciated, that the configuration and contouring of the upper and lower jaw members can be changed to suit the shape of the central section of any game controller, and the present invention is not necessarily intended to be limited in this regard.

What is claimed is:

1. A mobile device holder for mounting a mobile computing device to a computer game controller, the mobile device holder comprising a support frame and a clamp member,
said clamp member comprising a lower jaw defining a recess configured to receive therein, in use, the base of a game controller, and an upper jaw configured, in use, to extend around the top of a said game controller, the lower and upper jaws being hingedly coupled together at a rear edge of said clamp, and releasably securable together at an opposing front edge thereof so as to, in use, encircle a central portion of a said game controller;
wherein said lower jaw comprises an inner surface facing said upper jaw and an opposing outer surface having thereon connecting means; and
the support frame includes a support member configured to removably receive and hold therein a mobile computing device, and means for removably securing said support frame to said connecting means of said lower jaw of said clamp member.

2. A mobile device holder according to claim 1, wherein said connecting means comprises a mounting recess defined by a pair of substantially parallel and spaced apart retaining edges provided or formed on said outer surface of said lower jaw of said clamp member, and wherein said support frame includes a tab configured to be received and retained in said mounting recess, in use.

3. A mobile device holder according to claim 2, wherein cooperative magnetic means are provided in said mounting recess and on said support frame, and configured to removably secure said support frame to said connecting means of said lower jaw of said clamping member.

4. A mobile device holder according to claim 1, wherein a front edge of said lower jaw comprises an outwardly extending lip including releasably securing means for, in use, securing the front edge of the lower jaw to cooperative securing means provided at the front edge of said upper jaw.

5. A mobile device holder according claim 4, wherein said releasably securing means comprises one or more magnets configured to be attracted to one or more magnets provided at the front edge of said upper jaw.

6. A mobile device holder according to claim 1, wherein said upper jaw comprises at least one opening therein for accommodating one or more control devices provided on a said game controller.

7. A mobile device holder according to claim 1, wherein said support frame comprises a support arm extending between a lower edge of said support member and said means for removably securing said support frame to said connecting means of said lower jaw of said clamp member.

8. A mobile device according to claim 7, wherein said support member is hingedly attached to said support arm by means of a releasably securing device.
